(19) United States
(12) Patent Application Publication
(10) Pub. No.: US 2008/0109196 A1
(43) Pub. Date: May 8, 2008

(54) Tools and Methods for Range Management

(75) Inventors: Kaare J. Remme, San Marcos, TX (US); David A. Nicosia, Kyle, TX (US); Kelly D. Hendrick, San Marcos, TX (US); Daniel C. Mitchell, San Marcos, TX (US); Cynthia A. Castle, Seguin, TX (US)

Correspondence Address: FULBRIGHT & JAWORSKI L.L.P., 600 CONGRESS AVE., SUITE 2400, AUSTIN, TX, 78701, US

(73) Assignee: THE REMME CORPORATION

(21) Appl. No.: 11/556,842

(22) Filed: Nov. 6, 2006

(51) Int. Cl. G06N 3/00

(52) U.S. Cl. 703/11

(57) ABSTRACT

Methods and tool are provided for managing rangeland in a consistent, repeatable and quantitative manner. A geospatial model of the land is created and used to select forage analysis targets and forage analysis routes within the land. Then, forage observation locations are determined from the forage analysis targets. Forage and area limiting attributes are then determined and applied to each forage observation location, and a representative extent of land is associated with each forage observation location. An amount of forage at each forage observation location is measured, and forage inventory is calculated based on the measured forage and relative spatial extent of land associated with each forage observation location. Land use policy may then be established, for grazing, hunting, recreation, and other uses.

### BACKGROUND OF THE INVENTION

1. Field of the Invention

The invention relates generally to the field of range management and more specifically to determining an amount of forage in a given extent of land.

2. Description of Related Art

A common need in the field of range management is a measure of the amount of forage within an extent of land. A measure or estimate of the amount of forage in a specific extent of land is used in a number of management decisions, for example, determining livestock grazing plans and schedules, for developing or revising livestock stocking rates, as a measure of the productivity of the rangeland for a variety of purposes including a surrogate measure of rangeland health, or as evidence of a certain level of productivity of rangeland, and many others. As a measure of productivity or a surrogate for general rangeland health, measures of forage in specific extents of land are extremely valuable in capital improvement projects such as road, fence, and water system development and enhancement, in appraisal and ownership matters, and nearly all multiple use decisions. Traditional methods described in the scientific literature, in rangeland management texts or in extension publications suffer from a number of deficiencies. Often the techniques of prior art are not related to a specific extent of land, rather they are based on regional generalizations or rules of thumb, or, they are based on subjective measures of constraints extrapolated over extremely large extents of land.

An example of the first case is use of a regional stocking rate as defined in NRCS technical publications to project an amount of forage available without measuring forage at all. Although the estimate can be applied to specific extents of land, the same estimate is meant to be applied regionally so that an adjacent, specific extent of land in the same region would use the same estimate. Clearly, there is often a discrepancy on either side of a fence caused by a multitude of factors. While regional estimates, for example, 12 acres per cow in west Texas, 2 cows per acre in east Texas, are better than nothing, these estimates do not consider location specific factors.

An example of the second case is use of a subjective assessment of the proportion of a pasture that might be usable, for example, 60% multiplied by the number of acres in the pasture, multiplied by one or the average of a number of forage measurements within the pasture. Although this technique begins to address location specific factors, it is still very broad and relies on subjective generalizations of factors over broad and very often diverse patches of rangeland.

Other examples of prior approaches include surveys, documented in scientific literature in the fields of ecology, biology and spatial sciences, to produce statistically unbiased measures of an amount of forage within a specific extent of land, but these techniques, while necessary and acceptable in a controlled research environment, are very often cost prohibitive in a production environment. This prior approach generally ignores the need for consistent, repeatable, operationally feasible and cost effective measures of forage in favor of accurate measures of forage.

Thus, a simplified, more consistent and repeatable approach for determining an amount of forage in a specific extent of land is needed.

### SUMMARY OF THE INVENTION

Shortcomings of the prior art are reduced or eliminated by the techniques disclosed here. These techniques include tools and methods for determining an amount of forage in a specific extent of land.

These techniques are applicable to a vast number of situations in which a measure of forage is needed for specific extents of land including situations that involve range activities like livestock grazing, wildlife management, hunting, and recreational activities, but also any number of other range activities like planning and executing prescribed bums, water harvesting, environmental assessments, for surface damage mitigation and remediation, capital improvement planning, and any other decision in which forage itself, or forage as a surrogate measure of some other rangeland attribute is a factor.

One embodiment involves a method including creating a geospatial model of the land, using the geospatial model to select forage analysis targets and forage analysis routes within the extent of land, selecting and validating forage observation locations and forage analysis routes within the extent of land, establishing forage and area limiting attributes and values at each forage observation location, establishing the representative extent of land associated with each forage observation location, measuring an amount of forage at the forage observation locations, and calculating a forage inventory based on the measured forage and relative spatial extent of land associated with a forage observation location.

Another embodiment involves a method including creating a geospatial model of the land, using the geospatial model to select forage analysis targets and forage analysis routes within the extent of land, selecting and validating forage observation locations and forage analysis routes within the extent of land, establishing forage and area limiting attributes and values at each forage observation location, establishing the representative extent of land associated with each forage observation location, measuring an amount of forage at the forage observation locations, calculating a forage inventory based on the measured forage and relative spatial extent of land associated with a forage observation location, comparing an estimate of the amount of forage consumed by the number and type of livestock and the duration of livestock grazing in a specific extent of land to determine when to either, a) measure forage and calculate a new forage inventory for a specific extent of land, or b) remove grazing livestock from a specific extent of land.

Another embodiment involves a method including creating a geospatial model of the land, using the geospatial model to select forage analysis targets and forage analysis routes within the extent of land, selecting and validating forage observation locations and forage analysis routes within the extent of land, establishing forage and area limiting attributes and values at each forage observation location, establishing the representative extent of land associated with each forage observation location, creating a coefficient (RMMS Forage Factor) for each forage observation location that includes the relative spatial extent of land associated with each forage observation location and any area limiting attribute values at each forage observation location and optionally a conversion factor (lbs. to AUM/AUD). The product of a forage observation and any forage limiting attributes and values and this coefficient, produces a forage inventory for the forage observation location.

Yet another embodiment involves a method including creating a geospatial model of the land, using the geospatial model to select forage analysis targets and forage analysis routes within the extent of land, selecting and validating forage observation locations and forage analysis routes within the extent of land, establishing forage and area limiting attributes and values at each forage observation location, establishing the representative extent of land associated with each forage observation location, measuring an amount of forage at each forage observation location, calculating a forage inventory based on the measured forage and relative spatial extent of land associated with each forage observation location, and aggregating a number of forage inventories at various levels.

Still another embodiment involves a method including creating a geospatial model of the land, using the geospatial model to select forage analysis targets and forage analysis routes within the extent of land, selecting and validating forage observation locations and forage analysis routes within the extent of land, establishing forage limiting attributes and values at each forage observation location, and communicating grazing policy and monitoring policy compliance through the use of forage limiting attributes and values

Another embodiment is a computer readable medium including instructions for accomplishing any of the aforementioned methods.

Other embodiments, features, and associated advantages will become apparent with reference to the following description of specific embodiments in connection with the accompanying drawings.

### BRIEF DESCRIPTION OF THE DRAWINGS

The following drawings illustrate by way of example and not limitation. Reference numerals should not be used to construe the claims. The order of the steps in the drawings and the reference numerals are only for ease of reference and are not meant to imply any necessary order in embodiments of the present tools unless the claims so indicate.

FIG. 1 is a flow chart describing steps and instructions of embodiments of the present methods and tools.

FIG. 2 is a flow chart describing an example of a particular embodiment the geospatial modeling step of FIG. 1.

FIG. 3 is a flow chart describing an example of a particular embodiment the selecting Forage Analysis Targets step of FIG. 1.

FIGS. 4A-C present a flow chart describing an alternate example of a particular embodiment the selecting Forage Analysis Targets step of FIG. 1.

FIGS. 5A-D are a set of maps illustrating concepts presented in Calculating a Usable Area dataset step of FIG. 2.

FIG. 6 depicts one example of step 108 of FIG. 1, modeling the relative spatial extent of land associated with a Forage Observation Location.

FIG. 7 is a table illustrating an example of FIG. 1 step 112.

### DETAILED DESCRIPTION OF ILLUSTRATIVE EMBODIMENTS

It should be noted that the terms “comprise” (and any form of comprise, such as “comprises” and “comprising”), “have” (and any form of have, such as “has” and “having”), “include” (and any form of include, such as “includes” and “including”), and “involve” (and any form of involve, such as “involves” and “involving”), are open-ended linking verbs. As a result, a method or computer readable medium that “comprises,” “has,” or “includes” one or more steps or instructions possesses those one or more steps or instructions, but is not limited to possessing only those one or more steps or instructions. Likewise, a step of a method, or an instruction of a computer readable medium, that “comprises,” “has,” or “includes” one or more features possesses those one or more features, but is not limited to possessing only those one or more features.

The terms “a” and “an” are defined as one or more than one unless this disclosure explicitly requires otherwise.

As may be appreciated from the claims, not all the steps, instructions, or limitations displayed in the figures or listed in this detailed description of particular embodiments need to be present in all embodiments. Techniques of this disclosure can be accomplished using a subset of the steps, instructions, or limitations described. In addition, the figures and this description are not intended to suggest any ordering of the steps or instructions, unless the claimed embodiments explicitly indicate such an order.

For ease of description, embodiments described in the detailed description are sometimes referred to as methods, or parts within embodiments described in the detailed description are sometimes referred to as steps. However, embodiments of the present methods and tools similarly include computer readable medium comprising instructions for effecting the methods, and steps within those methods, described in this description.

As is known in the art, a computer readable medium may be associated with a computer, a computer file, a software package, a hard drive, a floppy, a CD-ROM, a hole-punched card, an instrument, an ASIC, firmware, a “plug-in” for other software, web-based applications, RAM, ROM, or any other type of computer readable medium. This list is not by way of limitation.

The use of the term “or” in the claims is used to mean “and/or” unless explicitly indicated to refer to alternatives only or the alternatives are mutually exclusive.

### Glossary of Terms

Forage—Browse (the part of shrubs, woody vines, and trees available for animal consumption) and herbage (the aboveground material of any herbaceous plant) that is available and may provide food for grazing animals or be harvested for feeding. Holechek, 2004, Range Management Principles and Practices, 5^{th} Ed. Pearson/Prentice Hall
Usable Area—A bounded and defined area of range land satisfying a number of constraints regarding the ability of livestock to successfully graze in the area. Constraints usually include distance to a source of water, limited slope and man-made or natural boundaries (fences).
Forage Inventory—An estimate of the total amount of forage in an area of rangeland usually expressed as the number of pounds of forage or in terms of Animal Unit Months (AUMs) or Days (AUDs). An AUM is defined by the USDA as “the amount of forage required by one mature cow of approximately 1,000 pounds weight, with or without a calf, for 1 month.” An AUD is considered 1/30 of an AUM.
Forage Analysis Target—A location identified as a candidate for a Forage Observation Location
Forage Observation—A measurement of standing forage obtained by executing one or more forage measurement methods or techniques
Forage Observation Location—A location where Forage Observations are made
Forage Analysis Route—A subset of routes or roads that define a tour of Forage Observation Locations
RMMS Forage Factor—A pre-computed value that conveys the relative spatial extent and any area limiting attribute values associated with a particular Forage Observation Location. The value may or may not include a conversion from pounds of forage to AUMs or AUDs.

Specific embodiments of the invention will now be further described by the following nonlimiting example which will serve to illustrate in some detail various features. The following example is included to facilitate an understanding of ways in which the present techniques may be practiced. As should be appreciated from the claims, many changes can be made and not all the steps, instructions, limitations, and/or ordering of this example need to be part of all embodiments of the present tools. Techniques of the present methods and tools can be accomplished using a subset of the steps, instructions, and/or limitations in this example. Accordingly, the example should not be construed as limiting the scope of the present tools.

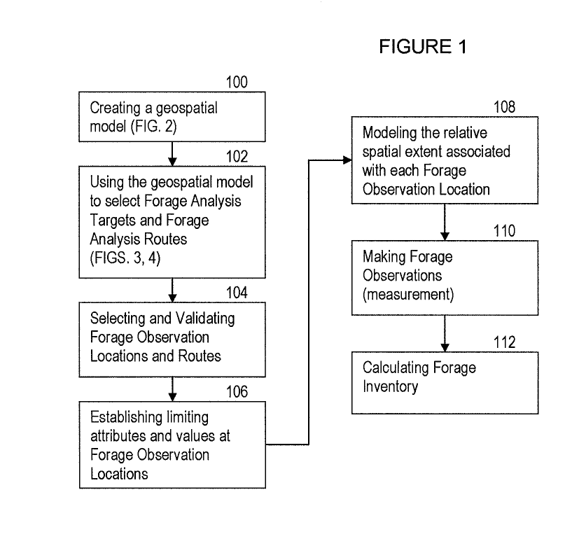

FIGS. 1-4 present flow charts describing an example of steps and instructions of embodiments of the present methods and tools. In a practical application, the flowcharts of FIGS. 1-4 are encoded in an appropriate machine readable form and stored on a computer readable medium, which, when loaded into a machine, for example, a computer, will cause the machine to perform the steps of the disclosed methods.

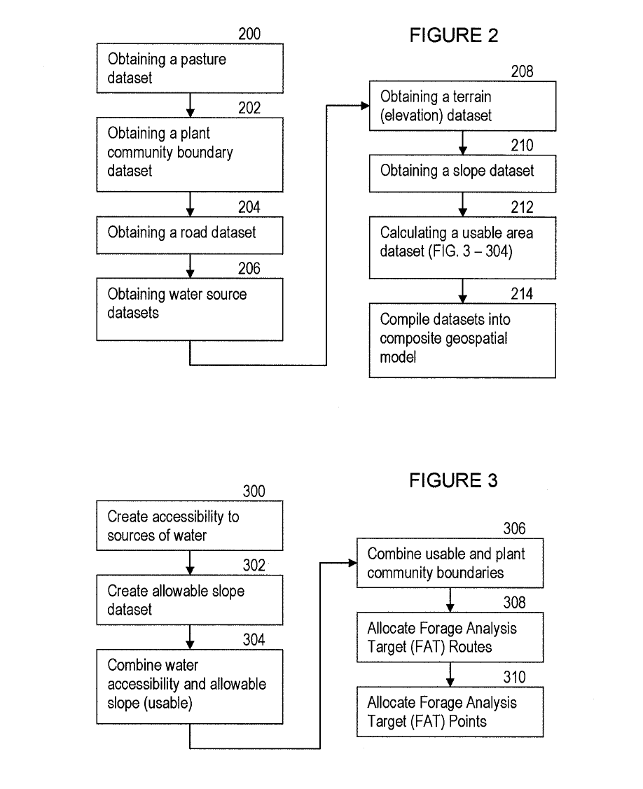

Referring to FIG. 1, shown is a high-level flowchart of an illustrative method of the present disclosure. Beginning in step 100, a geospatial model is created. Creation of a geospatial model is disclosed in more detail with reference to FIG. 2.

Referring to FIG. 2, steps 200, 202, 204, 206, 208, 210, and 212 are invoked in order to create, in step 214, a geospatial model of the land under management. The geospatial model includes the attributes of the objects, and the location, dimension and extent of the objects contained within. Objects in the model may be related based on attribute values, time, topology or any combination of these. The geospatial model includes geographic datasets; either “vector” datasets that record “entity” information, or “field” datasets that record a single attribute over space. Vector dataset features may be represented as points, lines or polygons, each of which has an associated set of attributes. Examples include pastures, water troughs and roads. Field (or raster) datasets may be represented as a continuous grid of a single attribute value over space. Examples of field datasets include elevation and slope. Datasets may be converted from one representation to another (sometimes with limitations as is well known in the practice of Geographic Information Systems (GIS)), for example a vector dataset may be converted to raster, or a raster dataset may be converted to vector so that the dataset may be of use in a particular situation. Any number of datasets may be included in the geospatial model, but a number of datasets are required for the present tools and methods. FIG. 2 includes a number of datasets that are pertinent to the present tools and methods, but others may be included in the geospatial model. The details of each of the steps invoked to create these datasets are discussed below.

Pastures (step 200)—Bounded (man-made using fences or by natural boundaries like cliffs or streams) areas used in practice as discrete grazing areas. These areas may be represented as vector polygons and may be obtained through any means, including, for example, digitization from aerial photography, from GPS data collection in the field or both. Instances in this collection of geospatial objects have the following attributes: geometry (polygon) and location, unique identifier, name, area, and optionally grazing season, or the periods during the year in which the pasture can be grazed.

Plant community boundaries (typically Range sites or Ecological sites) (step 202)—These areas, which may be represented as vector polygons, depict zones of specific mixes of forage plants. These data are available, for example, from the National Resource Conservation Service (NRCS) in the SSURGO dataset for most areas and are presented as either Range Sites or Ecological Sites. Attributes from this dataset that may be used include minimum annual forage production, maximum annual forage production, average annual forage production, the name or description of the range site or ecological site, and lists of plant species and their likely relative proportion within the community. The location and extent of these various plant communities help to identify where to measure forage, but also, how to apply the measurements to an extent of land. Many additional uses are possible.

Roads (step 204)—A vector line dataset containing roads, both public and private, within the managed area. Common public sources of roads include the US Bureau of the Census and state or local government or transportation authorities. Roads that are not reflected in a public dataset can be added from imagery or from GPS data collected in the field. This collection of objects may have the following attributes: geometry (line) and location, length, road surface type or classification, source of data (public, GPS collected), optionally direction and speed.

Sources of Water (step 206)—Sources of water may be stored in any vector data type, points (e.g. troughs or dirt tanks), lines (e.g. streams), or polygons (e.g. dirt tanks, lakes or ponds). Sources of water may be collected from many sources, including, for example, US Census datasets, local government (state, county, etc) data sources and/or from aerial photographs or in the field using GPS. The attributes for sources of water include: geometry (point, line, polygon) and location, source of data, indication of the functional status of the water source, meaning whether or not this water source is currently providing water (E.g. dry dirt tanks, intermittent streams, trough with broken water source), and optionally supply rate.

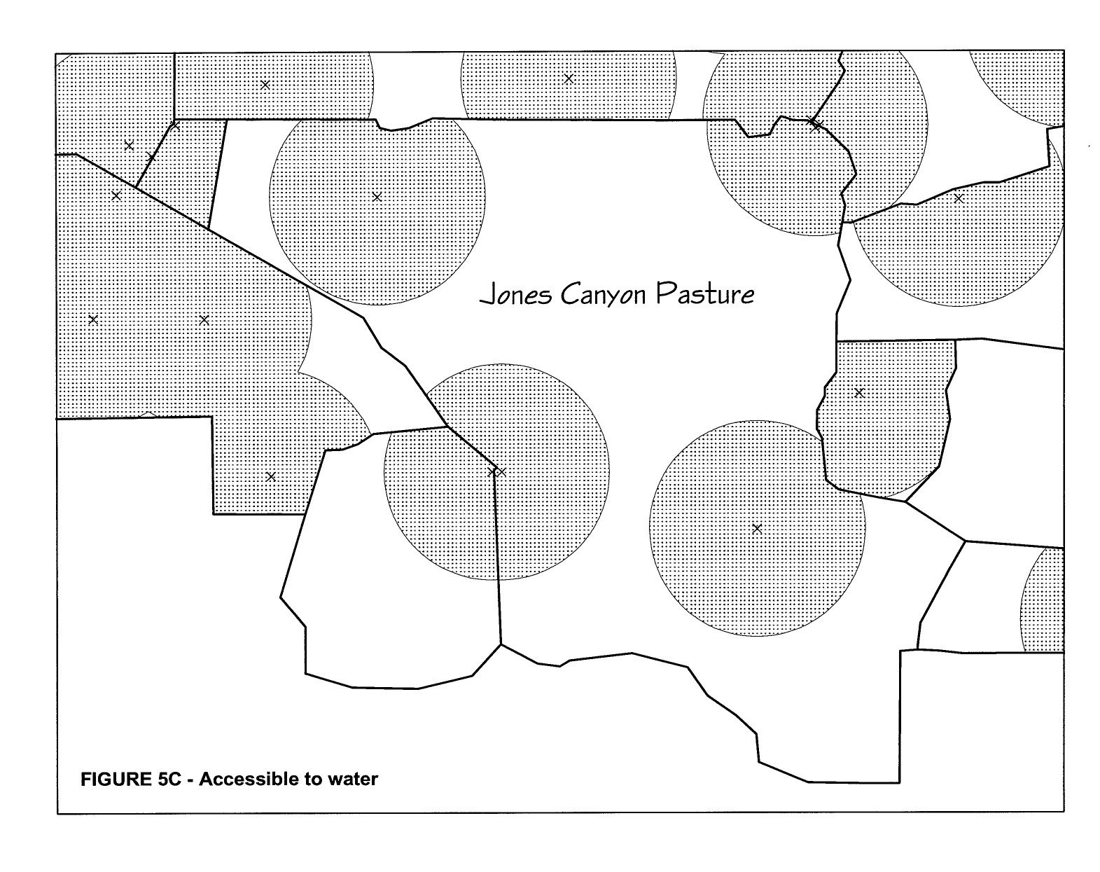

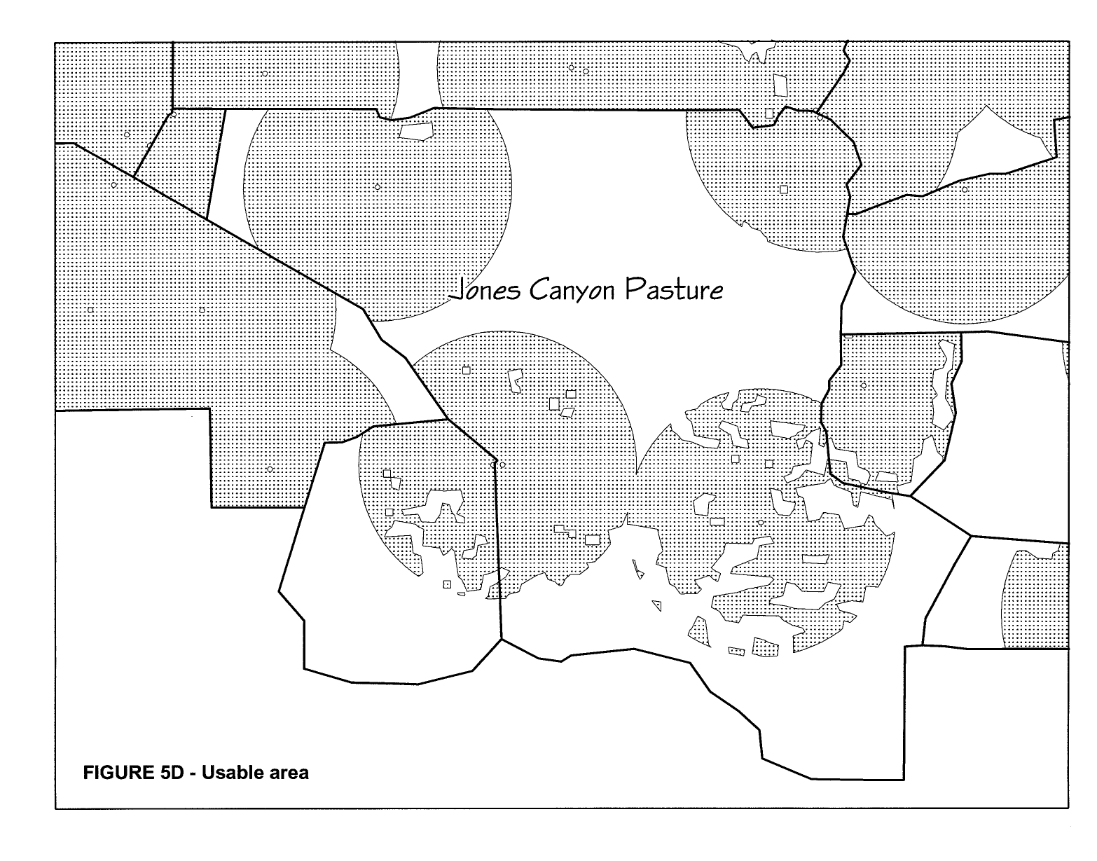

Usable Area (step 212)—Areas that are considered grazable by livestock. This dataset is derived from a collection of datasets and constraints that contribute to usability, including, for example: slope and accessibility to sources of water, each of which are explained in more detail below. FIGS. 5A-D include a set of maps illustrating determination of Usable Area (FIG. 5D) in a hypothetical extent of land called the “Jones Canyon Pasture.”

Slope—Slope (step 210) (raster) is derived from a digital elevation model (DEM) (step 208) which, for most places in the United States, is available from the USGS or from other commercial vendors, and may take the form of topographical maps. FIG. 5A is a topographical map of the hypothetical Jones Canyon Pasture with the isopleths representing constant elevations, and the dark lines representing pasture boundaries. The slope constraint used depends on the type of livestock. Animal behavior research indicates that cattle avoid slopes of greater than 20%, so this is the constraint normally used. Often the resulting raster slope dataset is converted to vector data, specifically polygons representing areas with slope less than or equal to 20%. The map of FIG. 5B is derived from the topographical map of FIG. 5A, and is a map of the hypothetical Jones Canyon Pasture with the shaded portion illustrating areas with slope less than or equal to 20%.

Accessibility to sources of water—Range science and animal behavior research indicate that livestock demonstrate a tendency to remain within relatively close proximity to water when grazing. Study results are numerous and varied, but generally speaking, the distance of one mile from water is used as a rule of thumb. Livestock often graze heavily in the areas immediately around sources of water quickly rendering the areas unusable. For this reason, areas immediately surrounding water sources, considered sacrifice areas, out to a radius of about 100 feet, are deducted from usable area. Another consideration is that of natural or man-made barriers that delineate “pastures.” Only sources of water that are in a pasture can be used to define water accessible areas within a pasture, meaning, although a source of water may be closer than one mile away, if it is on the other side of a fence, it is not accessible. To create water accessible areas, each feature in each water source layer may be buffered by some distance, usually one mile, and then intersected with the boundary of the containing pasture. Individual buffers for each water source within the containing pasture may be combined in order to get all areas within a mile of water within the containing pasture. Next, a sacrifice area buffer is created, usually at about 100 feet from the water source. The sacrifice buffer is subtracted from the 1 mile buffer area to produce water accessible areas. FIG. 5C is a map of the hypothetical Jones Canyon Pasture with the shaded portions illustrating water accessibility.

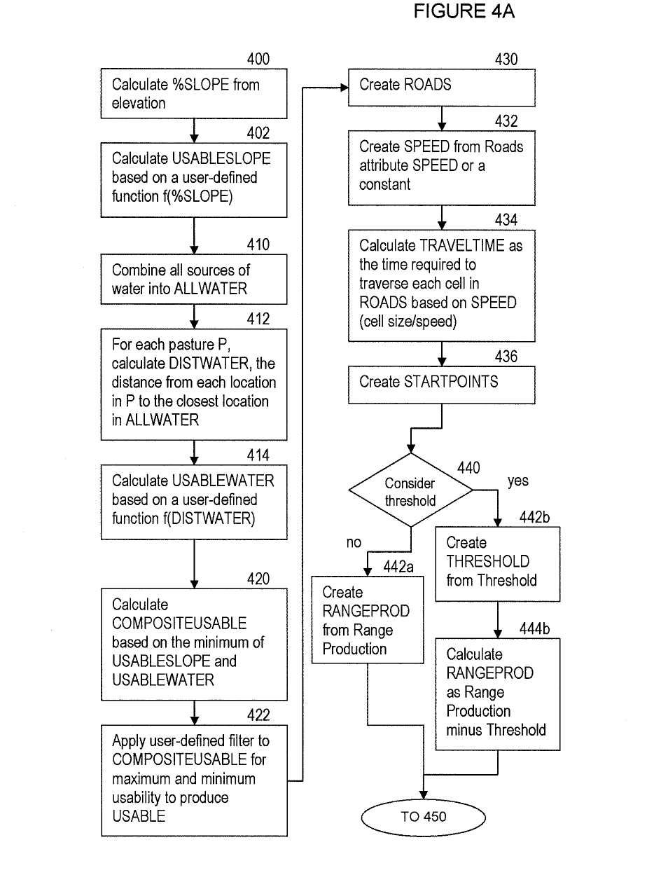

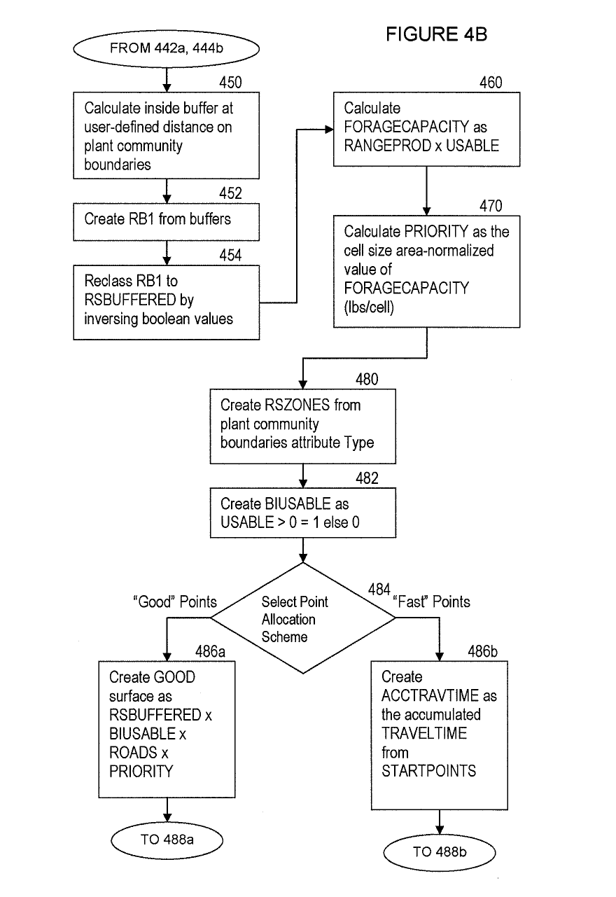

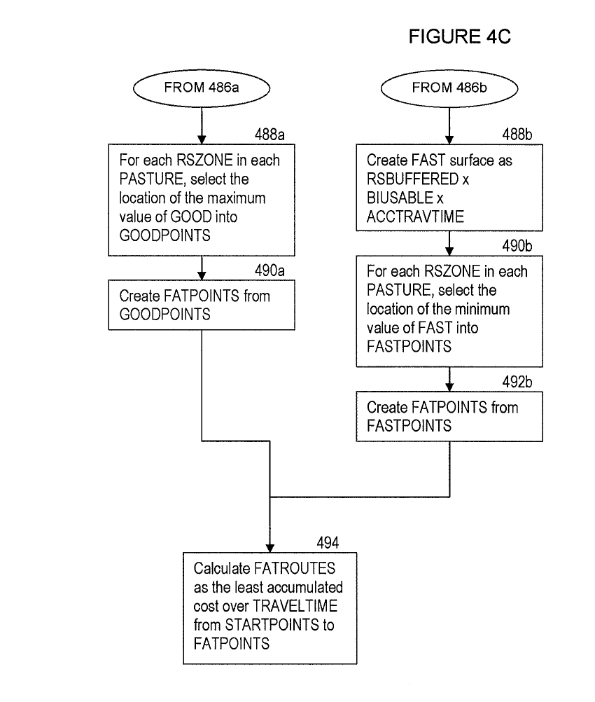

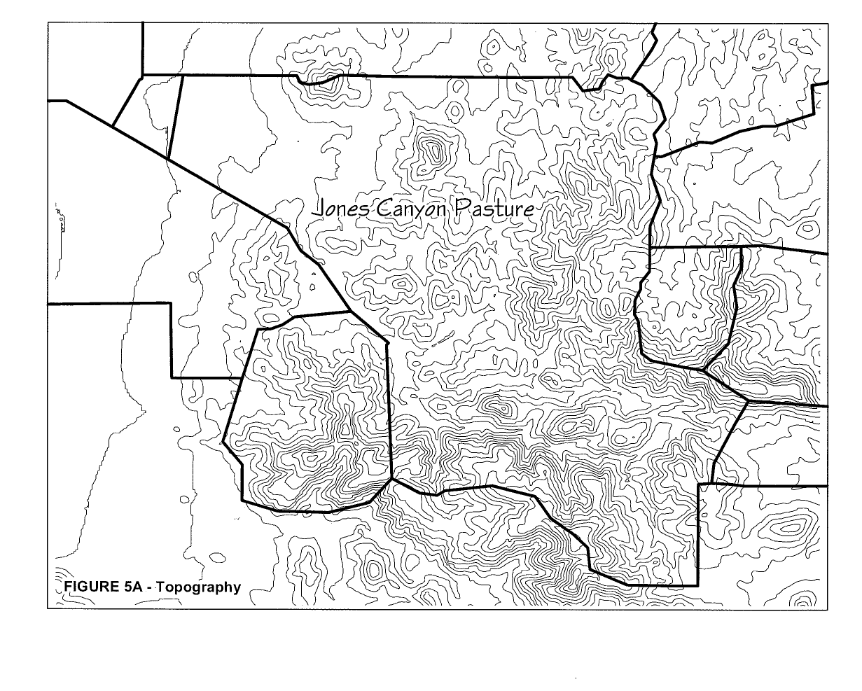

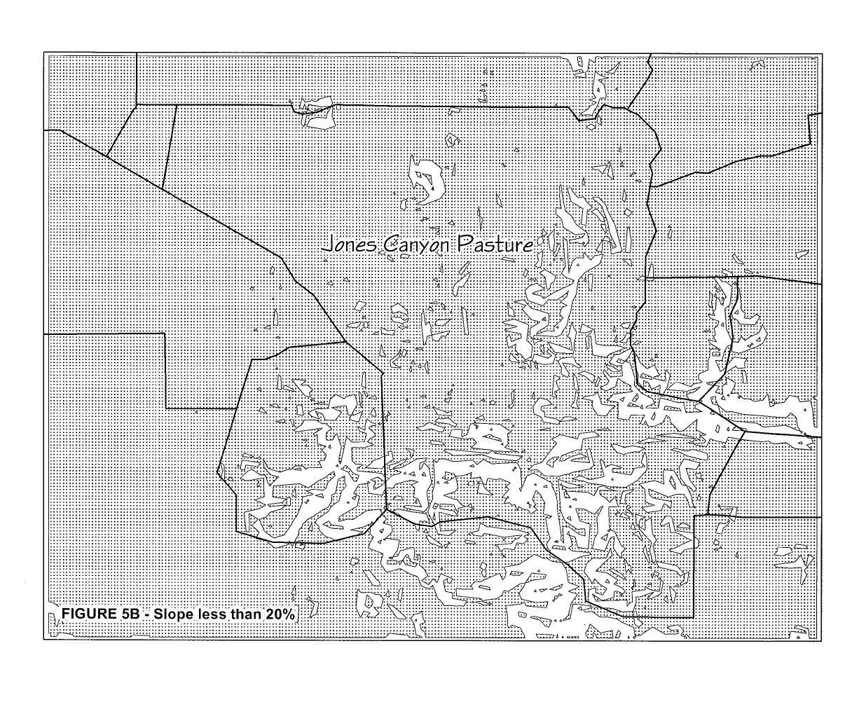

The geometric intersection of slope less than the constraining slope, for example, 20% (as a vector representation), and water accessible areas and pasture boundaries provides Usable Area (FIG. 2, step 212 and FIG. 5D). FIG. 5D is a map of the hypothetical Jones Canyon Pasture with the shaded portions illustrating Useable Ares. Attributes associated with Usable Area include: geometry (vector polygon) and location, area, and a relationship with the containing pasture. An alternative to the vector approach described above is a raster approach presented as a number of steps in FIG. 4A (steps 400-422).

Additional datasets may be added to these to produce, in step 214, a composite geospatial model of the land and pertinent features within a given extent. These data serve as a foundation of information upon which the user may rely for decision-making.

Referring back to FIG. 1, in steps 102 and 104, the geospatial model of step 100 is used to select the Forage Analysis Targets, Forage Analysis Routes, and Forage Observation Locations. Forage Analysis Targets may be selected before final selection and verification of Forage Observation Locations, and Forage Analysis Routes may be selected in any order with respect to Forage Analysis Targets and Forage Observation Locations. Two such embodiments of these steps are disclosed herein, but others are possible.

FIG. 3 describes an approach by which Forage Analysis Targets and Routes are selected using a map analysis technique.

The geospatial model of FIG. 1, step 100, is rendered as a map. The map contains a base layer depicting terrain. Scale permitting, the digital USGS topographic map (Digital Raster Graphic, DRG) (either 1:24,000 or 1:100,000 scale) may be used to show terrain. Otherwise, a hillshade or DLG (digital line graph, representation of USGS 1:24,000 scale contour lines) layer may be used. Other layers include: pastures, water sources (all available sources), Usable Area, ranch roads, Forage Analysis Routes (if they have already been identified), plant community boundaries (e.g. range sites or ecological sites), any other pertinent map features, and any other pertinent observation locations and/or routes for other observation purposes.

Pastures may be labeled with the pasture name, total pasture acres, and usable pasture acres. Range sites may be labeled by percent-composition of usable area by range site type (plant community) within each pasture.

Forage Analysis Routes, if not previously identified, may be selected (FIG. 3, step 308) from all ranch roads based on knowledge of common routes used in the field for various ranching tasks, for example, checking on cattle or sources of water. In particular, the routes selected may be primary operational roads that are used frequently and are well maintained. The selected roads may traverse the primary rangesites in each pasture. Because routes typically will be fixed, routes may be selected that provide segments which may be used to produce consistent but informal surveys of forage quantity and forage use for each pasture-rangesite combination. Forage Analysis Targets may be allocated along these routes so that they are accessible, yet still representative of the Usable Areas in each pasture. Points may also be selected along roads in order to accomplish sampling at points with a higher probability of use than points not on roads, since some animals, for example cattle, typically prefer to follow roads for easy traveling. This selection promotes conservatism in the forage inventory sampling and anticipates forage consumption site distribution factors. On the other hand some sites may be chosen because of their distance from roads or because of other characteristics that make the site less accessible to grazing livestock. In this way, in addition to being useful for determining a forage inventory, Forage Observation Locations, and thus Forage Analysis Routes, may be chosen to be useful as indicators of grazing pressure and grazing distribution factors.

Points may be allocated within Usable Areas of significant plant community types within each pasture. The significance of a plant community may be based on the extent of the area, or based on plant community productivity, both of these, or some other factor or combinations of factors. As an example, often riparian zones support unique and very productive plant communities, however, these areas may not be very wide and, by area may only represent a small fraction of the total pasture. The number or density of observation points may be defined ahead of time based on plant community type or forage productivity in the area, or by area (for example. no fewer than 1 point per 3 sections), or by some other criteria. Finally, Forage Analysis Targets may be allocated so that they are accessible, usually on or near main roads, the roads that serve as Forage Analysis Routes. However, as noted above, some Forage Analysis Targets, and thus the Forage Analysis Routes, may be located in less accessible areas in order to sample forage in these less accessible areas.

The results of FIG. 3, steps 308 and 310 include both the Forage Analysis Routes and Forage Analysis Targets. Final selection of Forage Observation Locations (FIG. 1 step 104) may be made in the field during an initial tour of the Forage Analysis Targets, but once established, the Forage Observation Locations and Forage Analysis Routes are preferably substantially fixed to promote consistency over time.

FIG. 4 presents an alternative approach for FIG. 1 steps 102.

Starting in step 400, a real raster percent slope (% SLOPE) is calculated from an elevation model. In step 402, a measure of the relative usability of the land is calculated based on a user-defined function:

USABLESLOPE=f(% SLOPE)

The purpose of the function is to allow the user to specify exactly how usability varies with slope. For example, for simplicity one might define an inverse linear relationship between percent slope and usability. Alternatively, one may choose to use a higher power inverse relationship, e.g. inverse with the square of percent slope, that more accurately reflects the behavior of the specific grazing livestock.

Next, in step 410, all sources of water, usually present in the geospatial model as vector datasets, are converted to binary rasters and combined into a composite binary raster ALLWATER.

In step 412, for each pasture extent, the distance to the nearest location of any source of water within the pasture is calculated. These datasets are combined for all pasture extents into a composite, real reaster DISTWATER. In step 414, a measure of the relative usability of the land is calculated based on a user-defined function:

USABLEWATER=f(DISTWATER)

The purpose of the function is to allow the user to specify explicitly how usability varies with distance to water. Once again, the user is free to choose a function that models the behavior of specific grazing livestock.

In step 420, usability as a function of slope (USABLESLOPE) and usability as a function of distance to water (USABLEWATER) are combined using the minimum value from either of the two surfaces to create COMPOSITEUSABLE, a real raster. In this way, the least usable input surface determines the value of the output surface, in other words, the surface represents the usability of the most limiting factor. In step 422, a user-defined minimum/maximum filter is applied to COMPOSITEUSABLE to produce the real raster USABLE. The purpose of the filter is to allow the user to determine limits on usability in further processing, for example, a user may wish to limit USABLE to 80% to 20% to avoid sacrifice areas and areas that are unlikely to be used.

Next, in steps 430, 432 and 434, roads are modeled. A number of road network related data are required for this embodiment. These data are described here. In step 430, a binary raster containing road information from the (usually) vector roads representation in the geospatial model is created as ROADS. This layer simply represents where roads are and are not. In step 432, a real raster, SPEED, is created from vector roads using the “speed” attribute if present, or a constant. This layer contains the maximum speed (or a constant) for each road within ROADS. In step 434, a real raster TRAVELTIME is calculated as:

TRAVELTIME=cell size/SPEED

where ROADS=true

This raster contains the time required to traverse each cell in ROADS based on SPEED and the size of the raster cell.

In step 436, defined starting points on ROADS are converted from a vector representation in the geospatial model or otherwise selected from ROADS. The selection is represented as a binary raster, STARTPOINTS. STARTPOINTS are used within this embodiment in conjunction with TRAVELTIME to allow automatic selection of Forage Analysis Routes. This process is described in more detail later in this document.

Steps 440 through 480 deal with various representations of the plant community boundary dataset (from FIG. 2, step 202). In this embodiment, the plant community boundary dataset may contain a number of attributes in addition to the type, location and extent of each plant community area. One attribute that may be present is the forage production capability of the plant community under some known climatic condition. (The NRCS SSURGO soil survey dataset typically includes 3 values; production under unfavorable, average, and favorable climatic conditions.) This attribute will be referred to as “Range Production.” Another attribute that may be present is a management or policy-defined value that reflects the minimum acceptable level of residual forage resulting from livestock grazing, termed “Threshold,” for the plant community area. This value may be established, for example, to promote ecological efficiency, to accumulate fuel for a prescribed burn, to combat erosion, to enhance some other rangeland value like water infiltration or wildlife habitat, for aesthetic reasons, or any other reason. In step 440, if the “Threshold” attribute is NOT to be used, the real raster layer RANGEPROD may be created (FIG. 4, step 442a) from the “Range Production” attribute or from a constant or enumeration of constants if the attribute is not present. If the Threshold attribute is present and is to be used, first a real raster, THRESHOLD, containing the Threshold value is created (FIG. 4, step 442b). Next, a real raster, RANGEPROD, is created as Range Production minus THRESHOLD (FIG. 4, step 444b).

Although the plant community boundary dataset provides a crisp delineation between plant communities, this is rarely the case in nature. Very often there is a transition zone between communities. In order to avoid placing Forage Observation Locations in these transition zones, this modeling process allows the user to select a distance from the boundary to avoid in placing Forage Analysis Targets. In step 450, it is necessary to create a buffer inward from the outside of each polygon within the plant community boundary to prevent further processing from including an area too close to a plant community boundary. Typically this operation is performed on the vector representation of the plant community dataset using the user-defined boundary distance. The vector boundary dataset may be converted to the boolean raster RB 1, (FIG. 4, step 452). RB 1 must be reclassed to its inverse as RB 1 has the value true where buffers are and false elsewhere. The inverse reclass produces, in FIG. 4, step 454, the boolean raster RSBUFFERED which contains the value true inside the buffered boundaries and false on the boundaries and the buffers.

Next, in step 460, the real raster FORAGECAPACITY is calculated as the product of RANGEPROD and USABLE. This surface represents the proportion of RANGEPROD that is usable. In step 470, FORAGECAPACITY is normalized to the cell size to produce a real raster PRIORITY. PRIORITY reflects the actual usable amount of forage, in specific terms (e.g. lbs), for each cell.

In step 480, the categorical raster RSZONES is created from the plant community boundaries attribute “Type.” This dataset simply identifies the location and extent of various plant communities. These zones represent subdivisions within a larger extent of land, for example, a pasture.

Next, in step 482, a boolean raster layer BIUSABLE is calculated as USABLE>0 then true, else false. This layer effectively creates a mask that indicates usable areas that conform to all of the user-defined specifications from steps 402, 414 and 422.

In step 484, a point allocation scheme must be selected. Two such schemes are described here for demonstration, but many others are possible. The first scheme, “Good Points,” allocates Forage Analysis Targets on roads at the location of maximum values of PRIORITY within each RSZONE within each pasture subject to all of the user-defined usability and plant community boundary constraints. These targets represent locations with the greatest productivity and usability subject to all of the constraints. The second scheme, “Fast Points,” seeks to allocate points within each RSZONE within each pasture subject to all of the user-defined usability and plant community boundary constraints, but also with minimal travel time along roads from STARTPOINTS. These targets favor ease of access.

In step 486a (Good Points), the real raster GOOD is calculated:

GOOD=RSBUFFERED×BIUSABLE×ROADS×PRIORITY

In step 488a, for each RSZONE in each PASTURE, select the location (cell) of the maximum value of GOOD into boolean raster GOODPOINTS. In step 490a, convert raster GOODPOINTS into vector FATPOINTS.

In step 486b (Fast Points), the real raster ACCTRAVTIME is calculated as the accumulated cost of TRAVELTIME from STARTPOINTS. In step 488b, the real raster FAST is calculated as:

FAST=RSBUFFERED×BIUSABLE×ACCTRAVTIME

In step 490b, for each RSZONE in each PASTURE, select the location (cell) of the minimum value of FAST into boolean raster FASTPOINTS. In step 492b, convert raster FASTPOINTS into vector FATPOINTS.

In step 494, the boolean raster FATROUTES is calculated as the least accumulated cost over TRAVELTIME from STARTPOINTS to FATPOINTS.

Referring back to FIG. 1, step 104, once Forage Analysis Targets and Forage Analysis Routes have been selected, Forage Observation Locations may be selected and verified in the field, along with any changes to Forage Analysis Routes. Field verification and selection of Forage Observation Locations and Routes allows the user to correct for factors not accounted for in the geospatial model. Forage Observation Locations may be selected from the Forage Analysis Targets, but other approaches may also be taken based on field verification.

In step 106, attributes that limit forage are selected and values are established at each Forage Observation Location. A great many factors influence the amount of forage available in an extent of land and vary widely based on the nature of the range. Some of the attributes are dynamic, like past grazing pressure, timing and amount of rainfall, climate, but some are relatively static. These static attributes may have values that are relatively fixed with respect to time, that is, they do not change, or they change very slowly, or change only through human intervention, like seeding or chemical or mechanical brush control. The attribute values, once established, remain substantially fixed so that the values function more as constants rather than variables when determining forage inventory. In this way, the temporal variability of forage measurement is substantially reduced providing results that are more consistent and reliable. Attributes may be categorized into forage limiting attributes and area limiting attributes. Forage limiting attributes include such items as a minimum forage residual, or an amount of forage which must be left un-grazed for effective ecosystem processes.. An often heard rule of thumb is “take half, leave half.” Another example is an adjustment for unpalatable or unfavorable forages, where only the amount of favorable forages is considered. Area limiting attributes include factors that reduce the effective area of the relative spatial extent. Examples include the amount of bare ground, the amount of brush cover, or the amount of surface covered by rock in the relative spatial extent, and so on. Values of these attributes at each Forage Observation Location are used to provide consistency in forage measurement by fixing as constants a number of factors that influence forage inventory.

In step 108, each Forage Observation Location is linked to a relative spatial extent of land. A forage inventory generally includes determining an amount of forage, through sampling, and extrapolating the value of the sample over some area. This step provides a consistent and repeatable measure of the area over which a Forage Observation may be extrapolated. One way in which relative spatial extents may be associated with Forage Observation Locations is by first calculating the intersection of each pasture and Usable Area. The intersection of this result and plant community boundaries produces, for each pasture, a set of plant community areas constrained to usable areas. A single Forage Observation Location within any of these areas may be associated with the containing area.

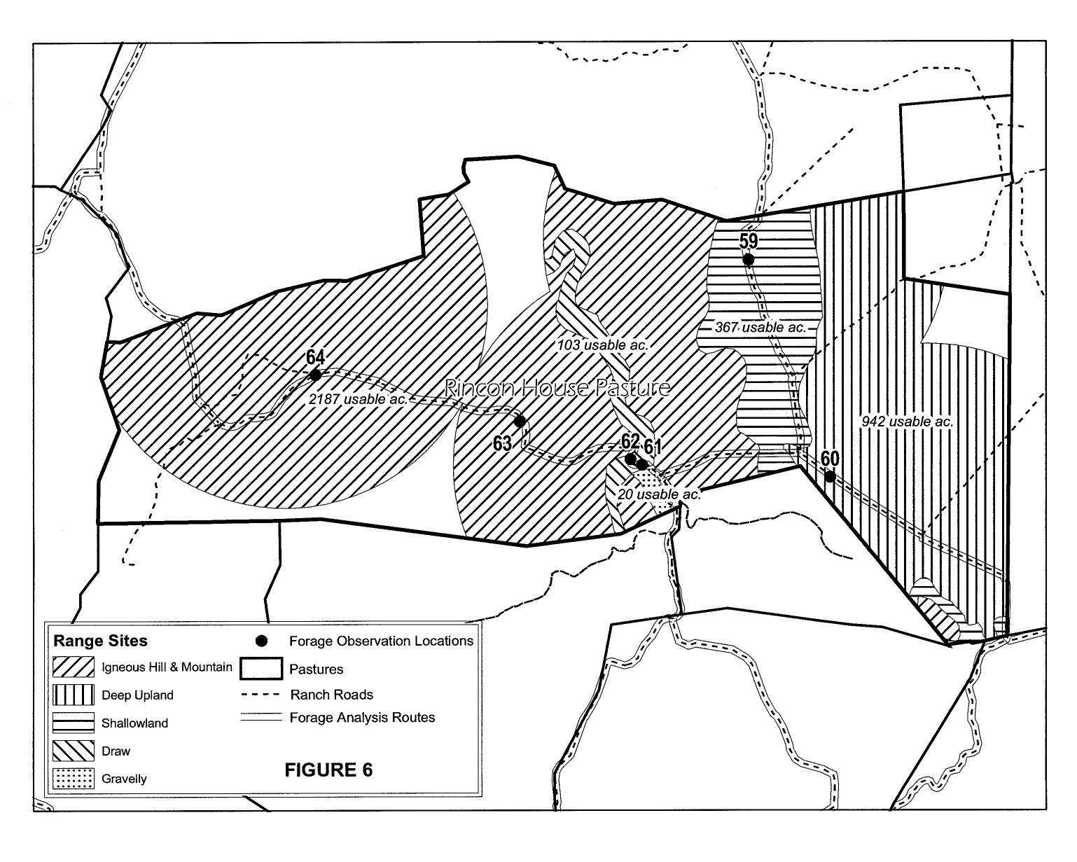

These concepts are illustrated with reference to FIG. 6 which deals with a hypothetical extent of land called the “Rincon House Pasture.” Referring to FIG. 6, Forage Observation Location 60, may be associated with 942 contiguous, usable acres of the Deep Upland rangesite type in which it is located. A Forage Observation Location may also be associated with any usable area of the same plant community type within the pasture in which there is no Forage Observation Location. For example, in FIG. 6, Forage Observation Location 59 may be associated with the 367 total, usable acres of the Shallowland rangesite type within the Rincon House Pasture, however, the 367 acres are split between the large extent of approximately 347 acres which contains the Forage Observation Location and the 20 acres of Shallowland rangesite type in the southeast comer of the Rincon House Pasture. In the event that there are multiple Forage Observation Locations within a single, usable contiguous plant community type within a pasture, each Forage Observation Location may be associated with the proportional area of contiguous usable plant community type within the pasture. For example, in FIG. 6, each of the two Forage Observation Locations, 61 and 62, each may be associated with 51.5 acres or exactly half of the 103 usable acres of the Draw rangesite type in the Rincon House Pasture. In the event that there are both multiple Forage Observation Locations within a single contiguous, usable plant community type within a pasture, and additional non-contiguous, usable areas of the same plant community type that do not contain Forage Observation Locations, then each Forage Observation Location may be associated with the proportional area of the sum of all usable areas of the same plant community type within the pasture. For example, in FIG. 6, Forage Observation Locations 63 and 64 may each be associated with 1093.5 acres, specifically, half of the sum of the contiguous extent of the Igneous Hill and Mountain rangesite type in which they are both located and the three other non-contiguous extents of Igneous Hill and Mountain rangesite type distributed throughout the Rincon House Pasture totaling 2,187 usable acres. Finally, if there are no Forage Observation Locations within any usable area of a particular plant community type within a pasture, as shown in FIG. 6, the 20 usable acres of the Gravelly rangesite type in Rincon House Pasture, then forage in these areas may not be included in the inventory.

Continuing in FIG. 1, in step 110, Forage Observations are made. There are a number of techniques available for measuring forage. Some rely on clipping and weighing a specific frame of forage. Some use forage height in conjunction with plant community information to produce a measure. Still others simply rely on an informed ocular estimate of the amount of forage. Any observation technique that can produce a measure of forage may implement the forage observation step. Forage Observations may be made according to a set, periodic schedule, for example at certain times of the year, or by season, or on an as-needed basis, for example, immediately before introducing livestock to or removing livestock from a pasture, or on the basis of some other indicator, for example, the measured amount of forage available in a pasture prior to the introduction of livestock relative to the calculated use of forage based on the number and duration of grazing livestock in a pasture. Forage Observations are temporal and recurring and are intended to produce measures of forage at the same locations over time.

In step 112, the results of Forage Observations are used to calculate forage inventory. A forage inventory is the sum of the products of a measured amount of forage and an area of land. The present methods seek to control, by reducing variability, the factors involved with calculating a forage inventory making a forage inventory more consistent and repeatable. This may be represented as:

FI=SUM(FM*NRSE) for the set of Forage Observation Locations

Where FI (forage inventory) is the sum of the products of the amount of forage, FM (forage measurement), over the area NRSE (net relative spatial extent).

The terms in the above equation may be expanded further to show how the present methods control for a number of factors. The summation notation highlights that forage inventory can be represented at various levels of aggregation, the least of which is the product of one Forage Observation at one Forage Observation Location and its' associated net relative spatial extent. If there is no Forage Observation or the observation is out of date or suspect for any other reason, the forage may not be inventoried. Individual Forage Inventories may be aggregated in numerous ways, for example by plant community type, by pasture, by region, by season of use of the pasture, by time, or any combination of these or other criteria. The expression FM includes two elements, the actual Forage Observation (FO), and any forage limiting attribute values (LVf):

FM=(FO−LVf)

For example, if, at a specific Forage Observation Location, a minimum forage residual (Threshold) is specified as a limiting value, the difference between the observed forage and the minimum residual is used as the forage measurement. If LVf (the minimum forage residual) equals 300 lbs/acre, and the observation is 700 lbs/ac, then FM equals 700−300, or 400 lbs/ac. In this case, a negative Forage Inventory would indicate that there is less than the minimum residual forage at the location, potentially a very important indicator, however, for the purposes of aggregation, a negative Forage Inventory is not factored into Forage Inventory because a deficit at one or more Forage Observation Locations can not be offset by a surplus of forage at another.

The expression NRSE (net relative spatial extent) is comprised of the RSE (relative spatial extent) associated with the Forage Observation Location, less any area limiting attribute values (LVa):

NRSE=(RSE−LVa)

For example, if, at a Forage Observation Location, the RSE equals 350 ac., and there are two limiting area attribute values, one for the presence of brush (10% brush cover) and one for the presence of bare ground (5% bare), then the NRSE equals 350 ac.−(35 ac. brush+17.5 ac. bare ground) or 297.5 ac.

For the above example, the FI (forage inventory) associated with the Forage Observation Location would be calculated as:

(700 lbs/ac.−300 lbs/ac.)*(350 ac.−(35 ac+17.5 ac.))=400 lbs/ac*297.5 ac.=119,000 lbs

It should be noted that forage inventory may be converted from calculated forage inventories into dry forage inventory using various known conversion methods.

It is common to express an amount of forage in terms of AUMs or AUDs. The conversion is based on an estimate of the amount of forage consumed by one Animal Unit for one day/month:

119,000 lbs/26 lbs/day (one AUD)=4,576.92 AUDs/30 days/month=152.56 AUMs

In this example, the AUD rate of 26 lbs/day may be adjusted to better match the nutritional requirements of specific grazing livestock. Alternatively, another measure of utilization may be used.

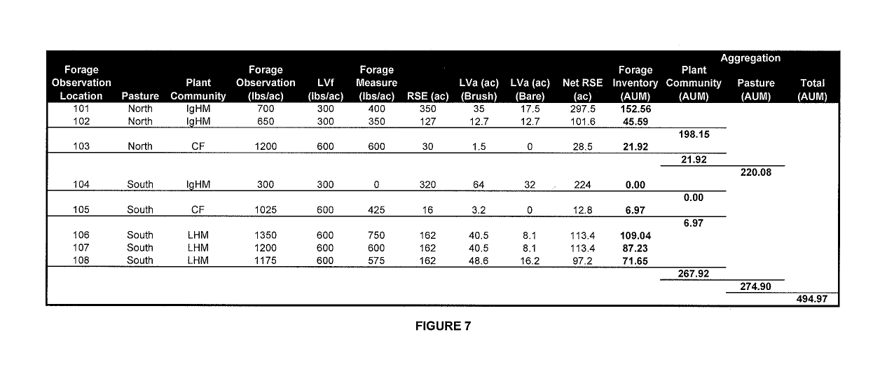

The table in FIG. 7 provides an example of various levels of forage inventory aggregation over two pastures. At the lowest level, there is a measure of forage for the relative spatial extent associated with the Forage Observation Location. Other examples include aggregation at the plant community-pasture level, the pasture level, and finally at the summary level for the entire managed land.

As may be seen above, it is possible to pre-compute NRSE based on assigned area limiting attribute values. This value, termed RMMS Forage Factor, provides a simple representation, a real coefficient, of a number of relatively complex concepts. Further, this value is valid for a Forage Observation Location until a) any one of the area limiting attribute values changes (typically rare), b) different assumptions are made about usable area and its' constituents (very rare), or c) a pasture changes (most rare). The result of the Forage Measurement expression may be multiplied by the RMMS Forage Factor (either including or not including a conversion to AUDs or AUMs) to produce a Forage Inventory for the associated Forage Observation Location.

Thus, in accordance with the above listed steps, the present disclosure is useful to accomplish at least one or more of the following desired results:
1. To provide consistent, repeatable and quantitative measures of forage for use as an input to sustainable grazing decisions (grazing systems, plans, etc.).
2. To provide an unambiguous method to define, communicate and evaluate grazing plans.
3. To provide an unambiguous method to define, communicate and evaluate terms, conditions, and results of grazing leases or other rangeland use policy, monitoring, and result determinations or other national or international equivalents.
4. To specify pasture (grazing land) deferment in terms of forage inventory (range production) rather than time.
5. To provide quantitative information to aid in creating, planning and executing capital investment projects, e.g. fences, roads, water distribution systems, etc.
6. To document forage availability as one quantitative measure of rangeland health.

Of course other features and advantages are also realized.

1. A method comprising:
creating a geospatial model of land;
selecting forage observation locations and forage analysis routes within said land, based upon the geospatial model;
establishing forage and area limiting attributes for each forage observation location;
establishing a representative spatial extent of land associated with each forage observation location;
measuring an amount of forage at each forage observation location; and
calculating a forage inventory based on the respective measured forage and representative spatial extent of land associated with each forage observation location.

2. The method of claim 1, further comprising:
the step of establishing forage observation locations further comprising, selecting forage analysis targets based upon the geospatial model; and selecting said forage observation locations based upon said forage analysis targets.

3. The method of claim 1, further comprising:
field validating said forage observation locations and forage analysis routes within the land.

4. The method of claim 1, further comprising:
estimating an amount of forage inventory; and
comparing the calculated forage inventory with the estimated forage inventory.

5. The method of claim 4, the estimating step comprising estimating an amount of forage inventory based upon a number and type of livestock and a duration of livestock grazing in a specific extent of land.

6. The method of claim 5, further comprising:
redistributing the livestock based upon the comparison.

7. The method of claim 1, the step of creating the geospatial model comprising:
establishing a usable area within the land based upon one or more attributes selected from the group consisting of: pasture boundaries, plant community boundaries, road locations, water source locations, terrain and slope.

8. The method of claim 1, further comprising:
creating a coefficient for each forage observation location based upon a relevant representative spatial extent of land associated with each forage observation location and area limiting attributes at each forage observation location; and
using the coefficient to calculate the forage inventory.

9. The method of claim 8, further comprising:
applying a conversion factor to the coefficient whereby the product of measured forage and the coefficient produces a forage inventory for the relevant forage observation location.

10. A computer readable medium comprising instructions for:
creating a geospatial model of land;
selecting forage observation locations and forage analysis routes within said extent of land, based upon the geospatial model;
establishing forage and area limiting attributes for each forage observation location;
establishing a representative spatial extent of land associated with each forage observation location; and
calculating a forage inventory for the land based on measured forage and relative spatial extent of land associated with each forage observation location.

11. The computer readable medium of claim 10, further comprising instructions for:
estimating an amount of forage inventory; and
comparing the calculated forage inventory with the estimated forage inventory.

12. The computer readable medium of claim 11, further comprising instructions for:
estimating an amount of forage inventory based upon a number and type of livestock and a duration of livestock grazing in a specific extent of land.

13. The computer readable medium of claim 10, further comprising instructions for:
establishing a usable area within the land based upon one or more attributes selected from the group consisting of: pasture boundaries, plant community boundaries, road locations, water source locations, terrain and slope.

14. A method of establishing livestock grazing policy, comprising:
creating a geospatial model of grazing land;
selecting forage analysis locations and forage analysis routes within the grazing land, based upon the geospatial model;
establishing forage limiting attributes for each forage observation location;
establishing a representative spatial extent of land associated with each forage observation location;
measuring an amount of forage at each forage observation location;
calculating a forage inventory based on the respective measured forage; and
establishing livestock grazing policy based upon the calculated forage inventory.

15. The method of claim 14, further comprising:
the step of establishing forage observation locations further comprising, selecting forage analysis targets based upon the geospatial model; and selecting said forage observation locations based upon said forage analysis targets.

16. The method of claim 14, further comprising:
field validating said forage observation locations and forage analysis routes within the land.

17. The method of claim 14, further comprising:
estimating an amount of forage inventory; and
comparing the calculated forage inventory with the estimated forage inventory.

18. The method of claim 17, the estimating step comprising, estimating a forage inventory based upon a number and type of livestock and a duration of livestock grazing in a specific extent of land.

19. The method of claim 18, further comprising:
redistributing the livestock based upon the comparison.

20. The method of claim 14, the step of creating the geospatial model comprising:
establishing a usable area within the grazing land based upon one or more attributes selected from the group consisting of: pasture boundaries, plant community boundaries, road locations, water source locations, terrain and slope.
